(19) United States
(12) Patent Application Publication
(10) Pub. No.: US 2016/0361826 A1
(43) Pub. Date: Dec. 15, 2016

(54) HAIR TRIMMER WITH VACUUM COLLECTION SYSTEM

(71) Applicant: Spectrum Brands, Inc., Middleton, WI (US)

(72) Inventor: Timin Ahmad Musallam, Sun Prairie, WI (US)

(21) Appl. No.: 15/181,585

(22) Filed: Jun. 14, 2016

Related U.S. Application Data
(60) Provisional application No. 62/175,860, filed on Jun. 15, 2015.

(51) Int. Cl. B26B 19/44; B26B 19/04

(52) U.S. Cl. CPC B26B 19/44; B26B 19/04

(57) ABSTRACT

A hair clipper includes a cutter head having a reciprocating blade for cutting hair. The blade has two lateral edges and a blade edge extending between the lateral edges. The lateral edges define a blade width. The hair clipper also includes an intake adjacent the cutter head. The intake has a front edge and two side edges together forming an opening for receiving hair clippings. The side edges define an opening width that is approximately equal to the blade width. The front edge is spaced from the blade edge a first distance between about 15 mm and 30 mm. The hair clipper further includes a vacuum system for creating an airflow to draw hair clippings into the intake.

### CROSS-REFERENCE TO RELATED APPLICATIONS

This application claims priority to U.S. Provisional Patent Application Ser. No. 62/175,860 filed on Jun. 15, 2015, which is incorporated herein by reference in its entirety.

### BACKGROUND

This invention relates generally to apparatus for trimming hair, and more particularly to hand-held hair trimming apparatus having a self-contained vacuum system for collecting hair clippings during use.

Hand-held hair clippers and trimmers have been used to cut hair in barber shops and private homes for many years. For example, hair clippers are commonly used to cut the hair on one's head, to trim moustaches and beards, hair around nasal passages and ears, as well as hair on various other body locations. Such hair clippers and trimmers typically comprise a housing sized and shaped to be held comfortably in one hand, and a cutting assembly mounted at one end of the housing. The cutting assembly commonly comprises a stationary toothed blade and a reciprocating toothed blade slidably mounted adjacent the stationary blade and driven back and forth by a motor enclosed in the housing. A comb may be mounted on the end of the housing to guide hair into the cutting assembly and to generally control the length of the cut.

The hair clippings produced by many conventional hair trimmers simply fall away from the apparatus onto the person whose hair is being trimmed or are otherwise scattered about the area of use. To this end, some hair clippers have been designed to operate in conjunction with an internal or external vacuum system for collecting the hair clippings as the hair cutting is performed. This can reduce the amount of cleaning needed after the cut is finished. One example of an internal vacuum system, U.S. Pat. No. 6,978,547, discloses a motor that operates trimmer blades to cut hair and rotates an impeller to create vacuum suction to direct hair clippings into an air intake. A similar vacuum arrangement is disclosed in U.S. Pat. No. 3,905,099. Such systems have been limited, however, by not having optimal intakes for collecting hair clippings. For example, the intakes are improperly sized and shaped for collecting long hairs and, therefore, long hairs may become trapped in the intakes. Additionally, the intakes fail to collect short hairs that are deflected away from the intakes prior to the short hairs being pulled into the intakes by the vacuum force. As a result, an undesirable amount of clipped hairs may not be captured by the vacuum systems.

There is a need, therefore, for an improved hair trimmer capable of clipping hairs and drawing a greater amount of the hair clippings into a vacuum system through an intake.

### SUMMARY

In one embodiment, a hair clipper is provided. The hair clipper comprises a cutter head having a reciprocating blade for cutting hair. The blade has two lateral edges and a blade edge extending between the lateral edges. The lateral edges define a blade width. The hair clipper also comprises an intake adjacent the cutter head. The intake has a front edge and two side edges together forming an opening for receiving hair clippings. The side edges define an opening width that is approximately equal to the blade width. The front edge is spaced from the blade edge a first distance between about 15 mm and 30 mm. The hair clipper further comprises a vacuum system for creating an airflow to draw hair clippings into the intake.

In another embodiment, a method of assembling a hair clipper having a reciprocating blade and an internal vacuum system is provided. The method comprises positioning the vacuum system inside a housing to draw airflow through the housing. The method further comprises attaching the reciprocating blade to the housing and operatively coupling the reciprocating blade to a motor. The motor is operable to drive the reciprocating blade to cut hairs. The reciprocating blade has a blade width and a blade edge. The method also comprises attaching a collection bin to the housing. The collection bin at least partly defines an airway for the airflow through the housing. The collection bin is configured to collect hair clippings drawn in the airflow through the housing. The method further comprises positioning an intake adjacent the reciprocating blade for receiving the hair clippings. The intake is in flow communication with the collection bin. The intake has a front edge and two side edges together forming an opening for receiving hair clippings. The side edges define an opening width that is approximately equal to the blade width. The front edge is spaced from the blade edge a first distance. The first distance is between about 15 mm and 30 mm.

In yet another embodiment, a hair clipper having a housing, an intake, a reciprocating blade, and an internal vacuum system is provided. The reciprocating blade has a blade edge and a blade width. The intake comprises a first side wall having a first side edge and a second side wall having a second side edge. The first and second side edges each have a parallel portion and an angled portion. A back wall has a back edge. The back wall extends between the side walls. The intake further comprises a front wall having a front edge. The front wall extends between the side walls. The edges together form an opening for receiving hair clippings. The side edges define an opening width that is approximately equal to the blade width. The front wall angles away from the back wall.

In still another embodiment, a hair clipper is provided. The hair clipper comprises a cutter head having a reciprocating blade for cutting hair and an intake adjacent the cutter head. The intake forms an opening for receiving hair clippings. The opening has an area in the range of about 300 mm² to about 800 mm². The hair clipper further comprises a housing at least partially defining an airway and a vacuum system for creating an airflow to draw hair clippings into the intake and through the airway. The vacuum system is configured to generate a negative pressure at the opening in the range of about 245 Pa to about 625 Pa. The hair clipper also comprises a screen positioned at least partially in the airway between the intake and the vacuum system. The screen having an overall area and mesh openings defining a flow-through area. The flow-through area being at least about 46& of the total area of the screen. The ratio of the area of the intake to the area of the screen is at least about 18:50.

### BRIEF DESCRIPTION

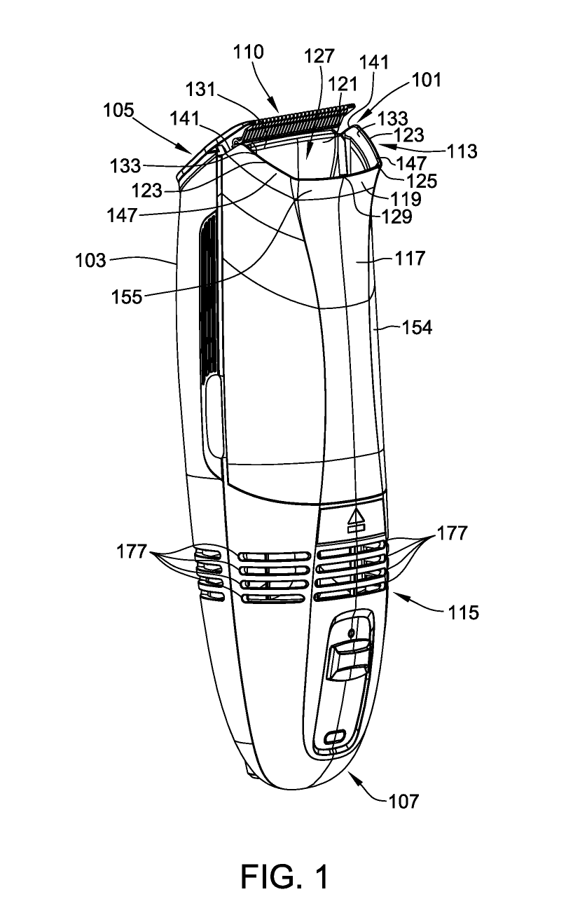

FIG. 1 is a perspective view of one embodiment of an electric hair trimmer;

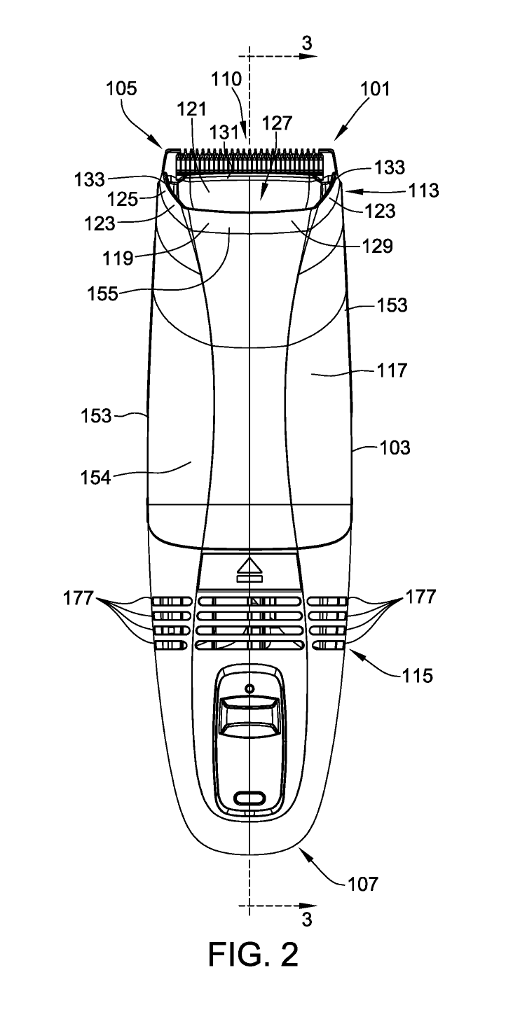

FIG. 2 is a front view of the trimmer of FIG. 1;

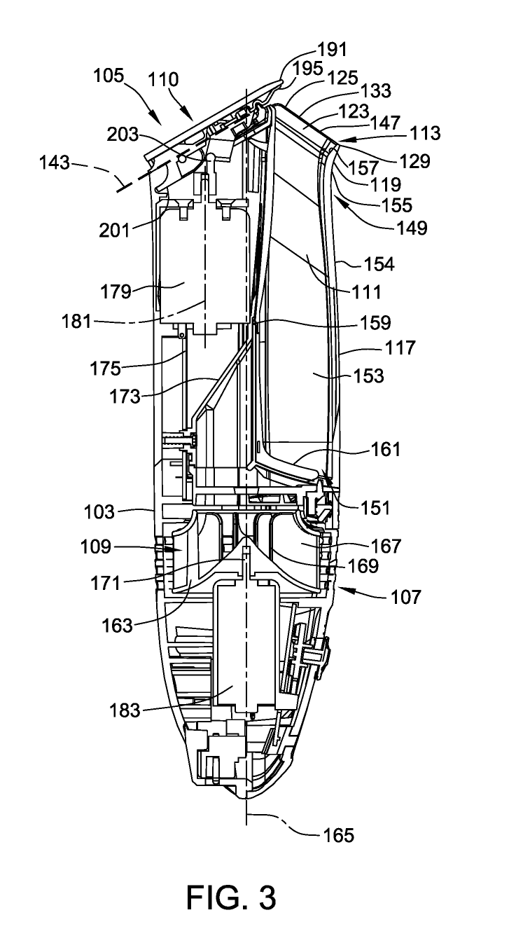

FIG. 3 is a cross-sectional view of the trimmer of FIG. 2 taken along section line 3-3 of FIG. 2;

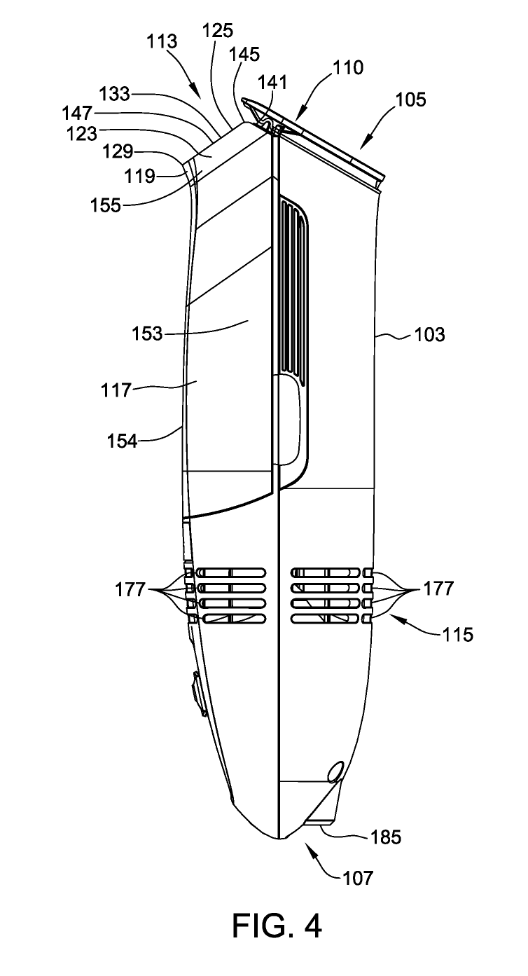

FIG. 4 is a side view of the trimmer of FIG. 1;

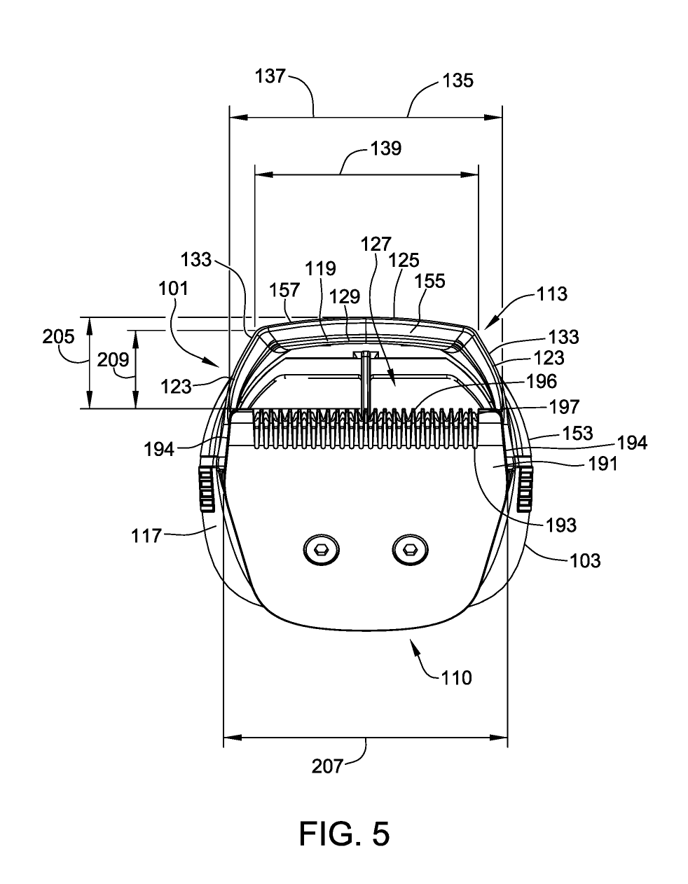

FIG. 5 is a top view of the trimmer of FIG. 1;

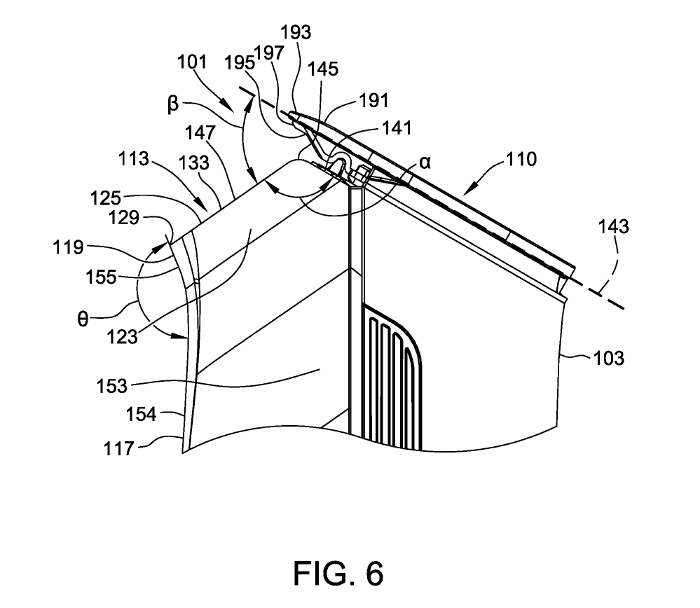

FIG. 6 is an enlargement of a portion of the side view of FIG. 4;

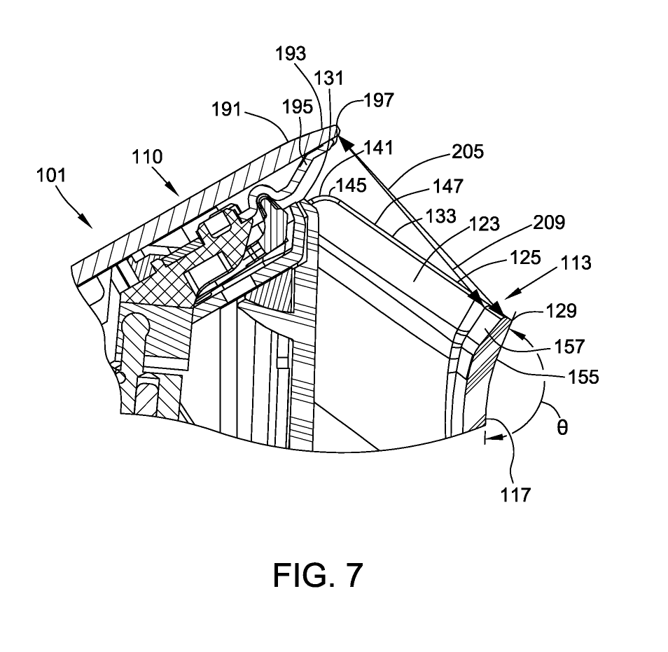

FIG. 7 is an enlargement of a portion of the cross-sectional view of FIG. 3; and

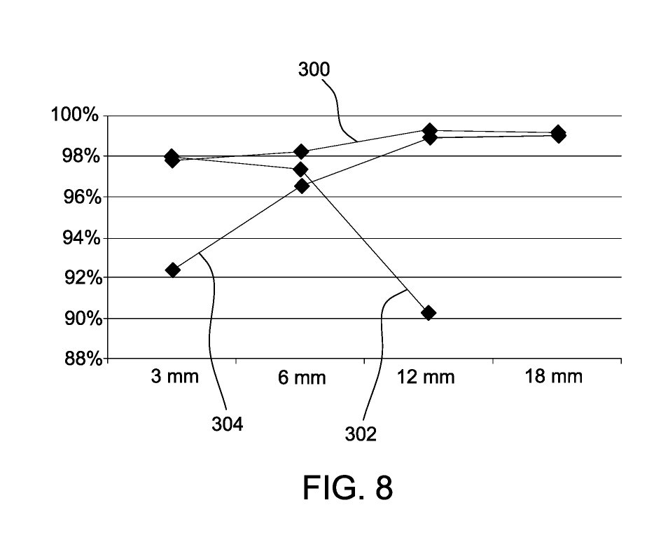

FIG. 8 is a graph illustrating percentages of hair collected for lengths of hair cut by tested hair clippers.

Corresponding reference characters indicate corresponding parts throughout the several views of the drawings.

### DETAILED DESCRIPTION

Referring now to the drawings and in particular to FIGS. 1 and 2, a hand-held apparatus for trimming hairs according to one embodiment of the present disclosure is generally designated 101. The hair trimming apparatus 101 generally comprises a housing 103 having an upstream end 105 and a downstream end 107 (the terms upstream and downstream referring to the general direction in which air flows through the housing as will be described), a vacuum source 109 disposed in the housing intermediate the upstream end and the downstream end thereof, and a trimmer assembly 110 (broadly, a cutting assembly) extending at least in part outward beyond the upstream end of the housing for trimming hair to produce hair clippings.

The housing 103 has an interior airway 111 (FIG. 3) extending from an intake 113 disposed generally at the upstream end 105 of the housing to an exhaust 115 generally intermediate the upstream end and the downstream end 107 of the housing. In other embodiments, the exhaust 115 and/or the intake 113 may be disposed nearer to the downstream end 107 or the upstream end 105 of the housing 103 than as illustrated in FIG. 1 and remain within the scope of this disclosure. The housing 103 is suitably sized and shaped for being held in one hand. A collection bin 117 is releasably secured to the housing 103 to in part define the interior airway 111 upstream of the vacuum source 109. The collection bin 117 facilitates the capture of hair clippings from the interior airway 111 before they reach the vacuum source 109.

The collection bin 117 is in flow communication with the intake 113. In the illustrated embodiment, the collection bin 117 and the intake 113 are integrally formed. In alternative embodiments, the intake 113 and the collection bin 117 may be separately formed.

In the illustrated embodiment, the intake 113 has a front wall 119, a back wall 121, and transversely opposite side walls 123 extending respectively between the front and back walls. In alternate embodiments, the intake 113 may comprise a singular circular wall or be shaped to have any suitable number of distinguishable walls. The intake walls 119, 121, and 123 may be any suitable materials, e.g., without limitation, plastics, metals, ceramics, and combinations thereof.

In the illustrated embodiment, the intake 113 has an edge 125 defining an opening 127 for receiving hair clippings into the housing 103. The edge 125 includes a front edge 129, a back edge 131, and side edges 133 extending along top portions of the respective front wall 119, back wall 121, and side walls 123. In suitable embodiments, the opening 127 may have any shape. In the illustrated embodiment, the opening 127 has a trapezoidal shape as best seen in FIG. 5. Accordingly, the opening 127 has an opening width 135 between the side walls 123. In the illustrated embodiment, the opening width 135 varies and, in particular, narrows or decreases from the back wall 121 toward the front wall 119. The opening width 135, in one example, has a maximum width 137 at the back wall 121 and tapers or gradually decreases to a minimum width 139 at the front wall 119. Suitably, in one particular example, the opening width 135 is between about 33 mm and about 48 mm and the maximum width 137 is between about 44 mm and about 48 mm. For example, in the illustrated embodiment the maximum width 137 is approximately 45 mm and the minimum width 139 is approximately 35 mm. In alternate embodiments, the opening 127 may be any shape having any constant or varying widths.

With reference now, in particular, to FIGS. 4 and 6, a parallel portion 141 of each of the side edges 133 extends in a direction parallel to a cutting plane 143 defined by the trimmer assembly 110. In the illustrated embodiment, the parallel portions 141 extend between an angle point 145 and the back edge 131. In addition, each side edge 133 has an angled portion 147, which is angled in relation to the cutting plane 143. Each angled portion 147 extends generally from the angle point 145 to the front edge 129. In suitable embodiments, each side edge 133 may have any number of portions extending in any direction that are angled or parallel in relation to the cutting plane. Additionally, each side edge 133 may include portions of any shape, such as curved portions.

At the angle point 145, the angled portion 147 and parallel portion 141 form an angle α, as best seen in FIG. 6. Preferably, the angle α is in the range of about 90° and about 140°. More preferably, the angle α is in the range of about 105° and about 125°. In the illustrated embodiment, the angle α is approximately 115°. The angled portions 147 also define an angle ρ relative to the cutting plane 143. Preferably, the angle ρ is in the range of about 40° and about 90°. More preferably, the angle ρ is in the range of about 55° and about 75°. In the illustrated embodiment, the angle ρ is approximately 65°. The angled portions 147 facilitate a user positioning the trimmer close to the user's skin to perform detailed trimming with minimal interference by the intake 113. Additionally, the angled portions 147 allow for the connection of standard combs (not shown) to the trimmer assembly 110.

Suitably, the intersections between the front wall 119, back wall 121, and side walls 123 are slightly curved to remove abrupt changes in direction along the interior surface of the intake 113. The smooth transitions between the walls 119, 121, and 123 limit the gathering of hair clippings at the intersections and inhibit the formation of turbulent airflow, which would reduce the efficiency of the vacuum.

The collection bin 117 includes an open end 149, at least partly defined by the intake 113, to permit the entry of air and hair clippings into the collection bin 117. A closed end 151 is opposite the open end 149, and opposing side walls 153 extend between the closed end 151 and the open end 149. An outer wall 154 extends between the opposing side walls 153. In the illustrated embodiment, the outer wall 154 and side walls 153 are configured to create a smooth contour with the housing 103 when the collection bin 117 is secured to the housing. The outer wall 154 and side walls 153 may be constructed of a translucent or transparent material so that a user can monitor the flow and collection of hair clippings in the collection bin 117.

In the illustrated embodiment, as best seen in FIG. 7, the front wall 119 flares generally upward and outward from the outer wall 154 of the collection bin 117, i.e., the front wall makes an angle θ with the outer wall of the collection bin. In one suitable embodiment, the angle θ is in the range of about 125° to about 180° degrees. In a further suitable embodiment, the angle θ is in the range of about 135° to about 175° degrees. In the illustrated embodiment, the front wall 119 flares out from the outer wall 154 such that the angle θ is approximately 155° degrees. Flaring the front wall 119 outward in this manner expands the opening 127 such that the opening can receive hairs of different sizes. Additionally, the flared front wall 119 provides an inclined surface 157 at the opening 127 to deflect and direct hairs into the intake 113. It is understood that in other embodiments of the collection bin 117, the front wall 119 may instead be linear with the outer wall 154 of the collection bin 117. It is also contemplated that one or both of the side walls 123 about the opening 127 may be flared upward and outward relative to the outer wall 154 of the collection bin 117 and remain within the scope of this invention.

A support web 159 opposite the outer wall 154 of the collection bin 117 is configured to hold in place a screen 161, and to prevent airflow through the collection bin other than through the screen 161. The screen 161 may be an essentially flat mesh member bent into an approximately semi-tubular profile, with a mesh aperture size configured to capture hair clippings from the airflow through the interior airway 111 while permitting airflow therethrough. Thus, the outer wall 154, the support web 159, the closed end 151, and the opposing side walls 153 define part of the interior airway 111, which enters the collection bin 117 at the open end 149 and exits the collection bin 117 through the screen 161. The screen 161 is elongated in a direction that is in part along the direction of airflow through the airway 111 to reduce interference with the airflow in the interior airway 111 by the captured hair clippings, thus avoiding an undesirable loss of vacuum strength. In addition, the screen 161 extends along a bottom of the collection bin 117 in a direction partially perpendicular to the direction of airflow. The bottom portion of the screen 161 allows airflow to travel the full length of collection bin 117 and inhibits hairs from obstructing portions of the collection bin 117 between the open end 149 and the closed end 151.

The screen includes mesh openings that allow airflow through the screen 161. The mesh openings define a total flow-through area of the screen. The total flow-through area at least partially determines the speed and amount of airflow through the screen 161. Moreover, the total flow-through area at least partially determines the vacuum strength of airflow at the intake 113 and the collection efficiency of the hair trimming apparatus 101. Preferably, the screen 161 has a total flow-through area that is at least about 46% of the overall area of the screen. In the illustrated embodiment, the screen 161 has a total flow-through area that is approximately 49% of the overall area of the screen.

The screen has an overall area that affects the airflow through the airway 111 and the collection efficiency of the hair trimming apparatus 101. For example, a ratio of the area of the opening 127 to the area of the screen 161 at least in part determines the vacuum strength of airflow at the intake 113. Preferably, the ratio of the area of the opening 127 to the area of the screen 161 is at least approximately 18:50.

The collection bin 117 is releasable from the housing 103 to facilitate emptying accumulated hair clippings from the collection bin 117. It is understood that any suitable releasable fastening techniques may be used to releasably secure the collection bin 117 to the housing 103 without departing from the scope of this invention. In alternative embodiments, one or more of the support web 159, the screen 161, the closed end 151, and the opposing side walls 153 may be formed unitarily with, or non-releasably coupled to, the housing 103, and the outer wall 154 may comprise a releasable access panel to permit emptying of hair clippings from the collection bin 117 while it remains secured to the housing 103. In some suitable embodiments, the intake 113 may be formed separately from the collection bin 117 and be releasably coupled to the collection bin 117 and/or the housing 103. In further suitable embodiments, the intake 113 may be formed unitarily with, or non-releasably coupled to the housing 103.

With reference now to FIG. 3, the vacuum source 109 according to one embodiment comprises a centrifugal fan 163 mounted in the interior airway 111. It is understood, however, that in other embodiments the vacuum source 109 may comprise other suitable fans, such as without limitation an axial-flow fan, without departing from the scope of the invention. The vacuum source 109 may also be other than a fan unit, such as an air pump (e.g., a diaphragm pump).

The fan 163 is rotatable about a rotation axis 165 oriented generally in the direction of airflow along the interior airway 111 from the intake 113 to the exhaust 115. The fan 163 comprises a plurality of arcuate vanes 167 extending generally radially outward from the rotation axis 165. In the embodiment of FIG. 3, the fan 163 comprises nine such vanes 167. In alternative embodiments, any suitable number of vanes 167 may be used. A central spindle 169 is configured to be rotationally coupled to a fan drive shaft 171 to drive rotation of the fan 163. The vanes 167 are suitably configured such that rotation of the fan 163 about its rotation axis 165 draws air into the intake 113 and downstream along the interior airway 111 to the fan.

A shaft cover 173 and a motor support 175 in the interior of housing 103 define a portion of the interior airway 111 upstream of the vacuum source 109, more particularly between the collection bin 117 and the vacuum source 109. The airflow passing through the screen 161 has velocity components normal to the airflow direction along the interior airway 111, and, in some embodiments, the section of the interior airway immediately upstream of the vacuum source 109 is configured to redirect those normal components of the airflow toward the exhaust 115. A plurality of exhaust openings 177 are formed in the housing 103 around at least a circumferential segment thereof to define the exhaust 115.

The vacuum source 109 is operably driven by an electric motor 179 disposed within the housing 103. As shown in FIG. 3, the location of the motor 179 may be offset from a generally longitudinal centerline 181 of the trimming apparatus 101 to facilitate location of the fan drive shaft 171 on or near the centerline 181. The motor 179 may suitably be powered by a rechargeable battery 183, or alternatively by a hybrid battery/capacitor, or the like, disposed within the housing 103 and chargeable via a cord socket 185 disposed near the downstream end 107 of the trimming apparatus 101. In other embodiments, the motor 179 may be powered by conventional batteries or directly by an external power source, such as a power cord surrounded in part by a suitable boot at the downstream end 107 of the trimming apparatus 101. The motor 179 is tuned to operate at a suitable rate for driving the trimmer assembly 110. For example, the motor may be operable in the range of about 5,000 rpm to about 10,000 rpm, and in a particularly suitable embodiment about 7,000 rpm.

The motor 179 rotates a motor output shaft 186 at a first rotational speed equal to the operating speed of the motor. In some embodiments, a transmission system (not shown) is used to rotate the fan drive shaft 171 at a second rotational speed that is greater than the first rotational speed. In certain embodiments, the offset location of the motor 179 relative to the centerline 181 of the trimming apparatus 101, as discussed above, also facilitates locating the fan drive shaft 171 parallel to, but transversely offset from, the motor output shaft 186. Upon operation of the motor 179 at its operating speed, the fan 163 is caused (via driven rotation of the driven gear and fan drive shaft 171) to rotate at a second rotational speed that is greater than the first rotational speed of the drive gear. As a result the rotational speed of the illustrated fan 163 is approximately 12,000 rpm upon operation of the motor at a speed of 7,000 rpm. In alternate embodiments, the fan 163 may operate at any suitable rotation speed.

With reference to FIGS. 5-7, the trimmer assembly 110 comprises a mounting plate 189, a fixed or stationary blade 191 secured to or integral with (as in the illustrated embodiment) the mounting plate and having cutting teeth 193 extending outward beyond the mounting plate, and a reciprocating blade 195 held in slidable contact with the stationary blade. In particular, the reciprocating blade 195 has cutting teeth 197 held in sliding contact with the cutting teeth 193 of the stationary blade 191 by a suitable spring assembly (not shown) disposed in the housing 103. In the illustrated embodiment, the reciprocating blade 195 includes two lateral edges 194 and a blade edge 196 extending between the lateral edges.

The reciprocating blade 195 is operatively connected to the electric motor 179 by a conventional drive assembly 199 having a recessed undercarriage 201. An eccentric pin 203 is mounted on or otherwise directly connected to the motor output shaft 186 for rotation thereof and is seated within the recessed undercarriage 201 to operatively connect the reciprocating blade 195 to the motor output shaft. Rotation of the eccentric pin 203 by the motor output shaft 186 drives the undercarriage 201 and hence the reciprocating blade 195 in reciprocating translation at a speed that corresponds directly with the rotational speed of the motor output shaft 186. Alternative embodiments may use other suitable structure for the drive assembly 199. Construction and operation of the trimmer assembly 110 and its operable connection to the motor 179 are known in the art and will not be described further herein except to the extent necessary to disclose the present invention.

The fan 163 causes air to be drawn into intake 113 and through interior airway 111. Thus, a vacuum is created around the intake 113 and reciprocating blade 195. When the reciprocating blade 195 cuts hair, the hair clippings are drawn by the generated vacuum into the intake 113. Notably, the size of the opening 127 in the intake 113 will affect the air velocity and vacuum strength near the trimmer assembly 110. Reducing the area of the opening 127 will increase the air velocity and vacuum strength and the increased air velocity and vacuum strength will draw a greater amount of clipped hairs into the intake 113. A higher air velocity and greater vacuum strength is especially important for collecting shorter hairs. If the vacuum strength is too weak, the shorter hairs can be deflected away from the intake 113 prior to being drawn into the airflow by the vacuum. However, a larger area of the opening 127 allows the intake 113 to collect larger hairs. Suitably, the opening 127 is sized to optimize the air velocity and vacuum strength and provide a sufficient area of the opening 127 to effectively collect hair clippings of all sizes.

The opening 127 has an area defined by the edge 125 of the intake 113. Specifically, in the illustrated embodiment, the angled portions 147 and the front edge 129 define the area at an angle relative to the cutting plane. Preferably, the opening 127 has an area between about 300 mm² and about 800 mm². In the illustrated embodiment, the opening 127 has an area of about 680 mm², resulting in an air velocity at the intake 113 of about 888 feet per minute and a vacuum strength of about 0.8391 air watts. Preferably, trimmer assembly 110 is configured to generate a vacuum strength in a range of approximately 0.5 air watts to approximately 1.5 air watts through the opening 127.

The negative pressure at the intake 113 is indicative of the vacuum strength that draws the clipped hairs into the intake 113. Preferably, the fan 163 is configured to generate a negative pressure at the opening 127 in the range of about 125 Pa to about 750 Pa. More preferably, the fan 163 is configured to generate a negative pressure at the opening 127 in the range of about 245 Pa to about 625 Pa.

As shown in FIG. 7, the front edge 129 of the intake 113 is disposed a distance 205 from the blade edge 196 of the reciprocating blade 195. Suitably, the distance 205 is between about 1 mm and about 5 mm greater than the length of the longest hair clippings intended to be taken into the trimming apparatus 101. As a result, the distance 205 facilitates hairs being drawn into the intake 113 without being trapped between the front edge 129 and the reciprocating blade 195. It has been found that the longest hair clippings cut by the described hair trimmer are typically between about 14 mm and 20 mm. Therefore, preferably, the distance 205 is between about 15 mm and about 25 mm. More preferably, the distance 205 is between about 18 mm and about 23 mm. In the illustrated embodiment, the distance 205 is approximately 22 mm, measured between the approximate midpoints of the intake 113 and blade edge 196. In other suitable embodiments, the intake 113 may be configured to receive hairs of any length and the front edge 129 may be disposed any distance from the reciprocating blade 195.

In the illustrated embodiment, the front edge 129 is closer to the reciprocating blade 195 at the ends than at the midpoint. Thus, the ends of the front edge 129 are spaced a distance 209 from the ends of the blade edge 196 that is less than the distance 205 between the midpoints of the front edge and the blade edge. Preferably, the distance 209 is between about 19 mm and about 20 mm.

In suitable embodiments, the front edge 129 may have any suitable straight or curved shape, and the front edge 129 may be spaced from the reciprocating blade 195 any constant or varying distance. In the illustrated embodiment, the front edge has a slightly rounded shape such that the front edge is substantially free from abrupt changes in direction, which could trap hair clippings.

As seen best in FIG. 5, the maximum width 137 of the opening 127 is slightly larger than a blade width 207 of the reciprocating blade 195 to facilitate the intake 113 receiving hair clippings deflected by the reciprocating blade. Preferably, the maximum width 137 is greater than the blade width 207 by at least the distance traveled by the reciprocating blade 195 during reciprocation such that the opening 127 extends beyond the blade throughout reciprocation of the blade. In the illustrated embodiment, the reciprocating blade 195 has a blade width 207 of approximately 40 mm and the opening 127 has a maximum width 137 of approximately 46 mm. In alternate embodiments, the reciprocating blade and opening may have any suitable widths.

The side walls 123, including the parallel portions 141 and angled portions 147, facilitate the intake 113 receiving short hair clippings that may be deflected away from the cutting plane. The side walls 123 are configured to drive airflow around the edges of the reciprocating blade 195 to draw deflected hairs into the intake 113. The space between the reciprocating blade 195 and the parallel portions 141, in particular, affects the air velocity and vacuum power of airflow around the reciprocating blade. Preferably, the parallel portions 141 are spaced from the reciprocating blade 195 a distance not greater than about 2 mm.

### Test Methods

Experimental testing was conducted to determine airflow characteristics of vacuum systems for various hair clippers. In particular, the hair clippers were tested to determine pressures and air watts of airflow at an intake of the vacuum systems. The testing was performed using an air watt testing fixture, tubing, an airflow meter, and sealant. The air watt testing fixture was a Dwyer DS-300 Flow sensor. The tubing was polyvinyl chloride (PVC) tubing with 1 in. and 2 in. diameters. The airflow meter was a Fluke 922 Airflow Meter.

### Pressure Testing

First, the hair clipper was positioned partially in the tubing having a 2 in. diameter. An end of the tubing was sealed around the body of the hair clipper such that the intake of the hair clipper was sealed within the tubing. An opposite end of the tubing was connected to the airflow meter by the tubing having a 1 in. diameter. Next, the airflow meter was activated and set to pressure mode. Then, the hair clipper was activated to generate airflow through the tubing. Once the pressure reading of the airflow meter stabilized, the pressure reading was recorded. The temperature of the atmosphere was recorded to allow for corrections of differences in pressure readings due to variations in temperatures. The hair clipper was turned off and the pressure reading was checked to ensure that the pressure reading was zero when the hair clipper was deactivated.

### Air Watts Testing

First, the hair clipper was positioned partially in the tubing having a 2 in. diameter. An end of the tubing was sealed around the body of the hair clipper such that the intake of the hair clipper was sealed within the tubing. Next, the air watt testing fixture was connected to the tubing and valves on the air watt testing fixture were positioned in an open position. A “Hi” output of the air watt testing fixture was connected to the “Input” fitting of the airflow meter and a “Low” output of the air watt testing fixture was connected to the “Ref” fitting of the airflow meter. The airflow meter was zeroed by holding a “Zero” button on the airflow meter. Then, the hair clipper was activated to generate an airflow through the airflow meter. Once the pressure reading of the airflow meter stabilized, the pressure reading was recorded. The temperature of the atmosphere was recorded to allow for corrections of differences in pressure readings due to variations in temperatures. Air watts of the airflow generated by the hair clipper were calculated based on the recorded pressure.

The air watts were calculated using the following formula:

Air Watts=Constant×Airflow×Pressure (1)

where the constant is 0.117354, the airflow is in units of cubic feet per minute, and the pressure is in units of inches of water.

### Test Results

Hair clippers having vacuum systems were subjected to testing to assess characteristics of the airflow generated by the vacuum systems. In particular, the air speed and air pressure of the airflows were assessed. The first tested hair clipper (Specimen 1) was an embodiment of a hair clipper according to the present disclosure. The other tested hair clippers (Specimens 2-4) were prior art hair clippers.

Table 1 includes the specifications of the tested hair clippers and Table 2 includes lengths of hairs collected by the tested hair clippers. Table 3 includes the results of pressure testing and Table 4 includes the results of air watt testing.

TABLE 1
Specifications of Tested Hair Clippers

| | | | | | | | Ratio |
|---|---|---|---|---|---|---|---|
| | | | | | | | of |
| | | | | | | | inlet |
| | | | | | | | area |
| | | | | | | | to |
| | | Inlet | Outlet | Fan | Inlet | Screen | screen |
| | Diameter | Diameter | Height | Blades | Area | Area | area |
| Specimen | (mm) | (mm) | (mm) | (mm²) | (mm²) | (mm²) | (%) |
| 1 | 40 | 26.65 | 14.33 | 9 | 680 | 1434 | 47:100 |
| 2 | 43.5 | 23.07 | 10.55 | 9 | 572 | 2242 | 13:50 |
| 3 | 34 | 15 | 19.8 | 9 | 280 | 780 | 18:50 |
| 4 | 30 | 20 | 21 | 5 | 135 | 386 | 7:20 |

TABLE 2
Length of Hairs Collected

| | Minimum Hair | Maximum Hair |
|---|---|---|
| Specimen | Length (in.) | Length (in.) |
| 1 | 0.125 | 1.5 |
| 2 | 0.25 | 1 |
| 3 | 0.0625 | 0.25 |
| 4 | 0.0625 | 0.25 |

TABLE 3
Results of Pressure Testing

| | Minimum | Maximum |
|---|---|---|
| | Negative Pressure | Negative Pressure |
| Specimen | (in. of water) | (in. of water) |
| 1 | 1.045 | 1.39 |
| 2 | 1.74 | 1.9 |
| 3 | 0.751 | 1.03 |
| 4 | 0.195 | 0.451 |

TABLE 4
Results of Air Watt Testing

| | Minimum Air | Maximum Air |
|---|---|---|
| Specimen | Watts | Watts |
| 1 | 0.8 | 1.144 |
| 2 | Inconclusive | 1.75 |
| 3 | 0.200 | 0.304 |
| 4 | 0.032 | 0.080 |

As shown in Table 1, the prior art hair clippers had a lower ratio of inlet area to overall screen area than the present disclosure hair clipper. The higher ratio of inlet area to screen area allows the present disclosure hair clipper to have a greater operating efficiency in comparison to prior art hair clippers.

The present disclosure hair clipper also has a screen with a greater amount of flow-through area in comparison to prior art hair clippers. For example, Specimen 4 had a flow-through area that was approximately 45% of the overall area of the screen. In contrast, the present disclosure hair clipper had a flow-through area that was approximately 49% of the overall area of the screen.

Moreover, the present disclosure hair clipper has a larger inlet area than the tested prior art hair clippers, which allows the airflow to draw larger hairs into the intake. In addition, as shown in Tables 3 and 4, the present disclosure hair clipper has the second highest maximum negative pressure and maximum air watts. The negative pressure and air watts of the present disclosure hair clipper allow the airflow to draw shorter hairs into the intake. As a result, the present disclosure hair clipper has a combination of features including a ratio of inlet area to screen area, intake area, negative pressure, and air watts that allows the present disclosure hair clipper to have an increased operating efficiency in comparison to the prior art hair clippers. For example, as shown in FIG. 8, the present disclosure hair clipper collects a greater range of lengths of hair and an increased percentage of hair clippings in comparison to the prior art hair clippers.

FIG. 8 is a graph illustrating percentages of hair clippings collected by tested hair clippers for different hair lengths. The Y-axis represents percentages of hair clippings collected in a range from 88% to 100%. The X-axis represents lengths of hair cut in a range from 3 millimeters to 18 millimeters. Curves 300, 302, and 304 represent the tested hair clippers. The curve 300 represents an embodiment of a hair clipper according to the present disclosure. The curves 302 and 304 represent prior art hair clippers. Notably, the present disclosure hair clipper collected greater than 96% of hair clippings for all tested hair lengths. In contrast, the prior art hair clippers each collected less than 94% of hair clippings for some tested hair lengths. Specifically, the prior art hair clipper represented by curve 302 collected less than 92% of hair clippings when the length of cut hair was approximately 12 millimeters. The prior art hair clipper represented by curve 304 collected less than 94% of hair clippings when the length of cut hair was approximately 3 millimeters.

Moreover, the present disclosure hair clipper collected the greatest percentage of hairs at a single cut length. The present disclosure hair clipper collected a maximum percentage of hair clippings when the length of cut hair was approximately 12 millimeters. The maximum percentage collected by the present disclosure hair clipper is greater than the percentages of hair clippings collected by the prior art hair clippers for any of the tested lengths of hair. Accordingly, based on the results of the tested hair clippers, the present disclosure hair clipper collected the greatest range of lengths of hair and the greatest percentage of hair clippings.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A hair clipper comprising:
a cutter head having a reciprocating blade for cutting hair, the blade having two lateral edges and a blade edge extending between the lateral edges, the lateral edges defining a blade width;
an intake adjacent the cutter head, the intake having a front edge and two side edges together forming an opening for receiving hair clippings, the side edges defining an opening width that is approximately equal to the blade width, the front edge being spaced from the blade edge a first distance, the first distance being between about 15 mm and 30 mm; and
a vacuum system for creating an airflow to draw hair clippings into the intake.

2. The hair clipper of claim 1 wherein the intake further comprises a front wall forming a scoop.

3. The hair clipper of claim 1 wherein the opening width is approximately 45 mm.

4. The hair clipper of claim 1 wherein the side edges each have an angled portion, the angled portions being angled in relation to a cutting plane of the cutter head.

5. The hair clipper of claim 4 wherein the side edges each have a parallel portion that is substantially parallel to the cutting plane.

6. The hair clipper of claim 5 wherein each angled portion makes an angle with the respective parallel portion in the range of about 90° and about 140°.

7. The hair clipper of claim 1 wherein the opening has an area between about 300 mm² and about 800 mm².

8. A method of assembling a hair clipper having a reciprocating blade and an internal vacuum system, the method comprising:
positioning the vacuum system inside a housing to draw airflow through the housing;
attaching the reciprocating blade to the housing and operatively coupling the reciprocating blade to a motor, the motor being operable to drive the reciprocating blade to cut hairs, the reciprocating blade having a blade width and a blade edge;
attaching a collection bin to the housing, the collection bin at least partly defining an airway for the airflow through the housing, the collection bin being configured to collect hair clippings drawn in the airflow through the housing;
positioning an intake adjacent the reciprocating blade for receiving the hair clippings, the intake being in flow communication with the collection bin, the intake having a front edge and two side edges together forming an opening for receiving hair clippings, the side edges defining an opening width that is approximately equal to the blade width, the front edge being spaced from the blade edge a first distance, the first distance being between about 15 mm and 30 mm.

9. The method of claim 8 further comprising forming the intake, the intake having a front wall that defines a scoop.

10. The method claim 8 further comprising positioning the side edges adjacent the reciprocating blade and aligning a parallel portion of each of the side edges parallel to a cutting plane of the reciprocating blade.

11. The method claim 8 further comprising aligning an angled portion of each of the side edges to make an angle with the cutting plane of the reciprocating blade.

12. The method of claim 11 wherein the angled portions each make an angle of between about 40° and 90° with the cutting plane.

13. A hair clipper having a housing, an intake, a reciprocating blade, and an internal vacuum system, the reciprocating blade having a blade edge and a blade width, the intake comprising:
a first side wall having a first side edge;
a second side wall having a second side edge, the first and second side edges each having a parallel portion and an angled portion;
a back wall having a back edge, the back wall extending between the side walls; and
a front wall having a front edge, the front wall extending between the side walls, the edges together forming an opening for receiving hair clippings, the side edges defining an opening width that is approximately equal to the blade width, the front wall angling away from the back wall.

14. The hair clipper of claim 13 wherein the front edge is spaced from the blade edge a first distance between about 15 mm and 30 mm.

15. The hair clipper of claim 13 wherein the front wall, back wall, and side walls are substantially smooth and free from abrupt changes in direction.

16. The hair clipper of claim 13 wherein the opening has a substantially trapezoidal shape, the opening width decreasing from the back wall to the front wall.

17. The hair clipper of claim 16 wherein the opening has an area between about 300 mm² and about 800 mm².

18. The hair clipper of claim 13 wherein the opening width is approximately 45 mm.

19. The hair clipper of claim 13 wherein the respective parallel and angled portions make angles of between about 90° and about 140°.

20. The hair clipper of claim 13 wherein each of the parallel portions extends from the back edge to an angle point and each of the angled portions extends from the angle point to the front edge.

21. A hair clipper comprising:
a cutter head having a reciprocating blade for cutting hair;
an intake adjacent the cutter head, the intake forming an opening for receiving hair clippings, the opening having an area in the range of about 300 mm² to about 800 mm²;
a housing at least partially defining an airway;
a vacuum system for creating an airflow to draw hair clippings into the intake and through the airway, the vacuum system configured to generate a negative pressure at the opening in the range of about 245 Pa to about 625 Pa; and
a screen positioned at least partially in the airway between the intake and the vacuum system, the screen having an overall area and including mesh openings defining a flow-through area, the flow-through area being at least about 46% of the overall area of the screen, the ratio of the area of the intake to the overall area of the screen being at least about 18:50, the vacuum system and the through area being configured to generate the airflow with a vacuum strength in a range of approximately 0.5 air watts to approximately 1.5 air watts through the opening.

22. The hair clipper of claim 21 wherein the intake comprises a front wall forming a scoop.

23. The hair clipper of claim 22 wherein the intake further comprises side edges each having an angled portion, the angled portions being angled in relation to a cutting plane of the cutter head.

24. The hair clipper of claim 23 wherein the side edges each have a parallel portion that is substantially parallel to the cutting plane.

25. The hair clipper of claim 23 wherein each angled portion makes an angle with the respective parallel portion in the range of about 90° and about 140°.

26. The hair clipper of claim 21 wherein a width of the opening is approximately 45 mm.
